(19) United States
(12) Patent Application Publication
(10) Pub. No.: US 2024/0030858 A1
(43) Pub. Date: Jan. 25, 2024

(54) SOLAR ENERGY TRACKING SYSTEM

(71) Applicant: Rodolfo Antonio Francisco DE SOUZA, Chorao, Ilhas, Goa (IN)

(72) Inventor: Rodolfo Antonio Francisco DE SOUZA, Chorao, Ilhas, Goa (IN)

(21) Appl. No.: 18/254,144

(22) PCT Filed: Nov. 26, 2021
(86) PCT No.: PCT/IB2021/060995

§ 371 Date: May 23, 2023

(30) Foreign Application Priority Data
Nov. 26, 2020 (IN) 202011051556

(51) Int. Cl. H02S 20/32; H02S 30/20

(52) U.S. Cl. CPC H02S 20/32; H02S 30/20

(57) ABSTRACT

The present invention discloses a surya solar system (1000). The system (1000) includes a rail (50). The system (1000) further includes a frame (102) mechanically connected to the rail (50). Further, the system (1000) includes solar panels (100) configured over the frame (102). The panels (100) and the frame (102) are operatively configured to the rail (50), thereby enabling the panels (100) to move on the frame (102) for tracking the sun for absorbing the maximum intensity of sunlight. The system (1000) further includes sensors (150) which is operatively coupled to the panels (100). The sensors (150) are adapted to generate signal as the sunlight received on the panels (100). The system (1000) includes a processing system 10 (200a) which is operatively connected with the sensors (150). The processing system (200a) processes the signal for tracking the maximum intensity of the sunlight.

### FIELD OF THE INVENTION

The present invention relates to a surya solar system, and more particularly to a surya solar system which is capable of tracking the sun and changing it's position for adsorbing maximum amount of sunlight.

### BACKGROUND OF THE INVENTION

Solar power is the key to a clean energy future. Every day, the sun gives off far more energy than we need to power everything on earth. That's why the world is investing heavily in solar related technology such as solar panels.

Further, no greenhouse gas emissions are released into the atmosphere when using the solar panels to create electricity. And, because the sun provides more energy than we'll ever need, electricity from solar power is a very important energy source in the move to clean energy production.

Solar panels are made up of photo voltaic cells. The Photovoltaic cells in a solar panel turn sunlight into direct current electricity (DC). Then, an inverter converts the DC electricity into alternating current electricity (AC), and once this process has taken place, the electricity is used, fed into the grid or stored in a battery.

Conventional solar panels track the sunlight in a restricted position, and thereby cannot track the maximum intensity of sunlight accurately.

The existing solar panels are fixed on the roof top and cannot do anything in bad weather conditions, as we know that heat, rain, wind, storm, snow, fire, surges, etc., are decisive factors in the performance of solar panels.

Therefore, there is a need to develop a surya solar system which may track the sun according to the maximum intensity of sunlight accurately.

Further, there is a need to develop a surya solar system which is adapted to protect the solar panels from any damage in bad weather conditions.

Moreover, it will be appreciated that outside weather plays a major role in the efficient working of solar panel. It may have both positive and negative effects. In general, the colder the weather the better, and warmer the worse, for the panel.

Therefore, there is need to develop a surya solar system which tries to strike a balance at best between both the conditions.

In nutshell, a surya solar system is required which may overcome above discussed drawbacks and provides easy to operate and a cost-effective system.

### SUMMARY OF THE INVENTION

In an aspect of the present invention, a surya solar system is disclosed. The surya solar system includes two parts. First is a rail. The second is a stand on which the rail is mountable.

In one embodiment of the present invention, the surya solar system further includes plurality of solar photo voltaic (PV) panels which are mounted or installed over the frame. The said solar panels are adapted to absorb sunlight for converting solar energy into electricity.

In an embodiment of the present invention, the said solar panels and the said frame are operatively configured to the said rail.

In various embodiments, the said solar panels are adapted in such a way that the said solar panels are movable on the said frame for tracking the sun for absorbing the maximum intensity of sunlight.

In one embodiment of the present invention, the said frame is mechanically connected to the said rail. The said frame is adapted to slide on the said rail via a sliding mechanism, thereby enabling the solar panels to track the maximum intensity of sunlight.

In the embodiment of the present invention, the said frame along with the panels slide on the said rail via the sliding mechanism which is provided on the said rail. Due to the said configuration, the said solar panels are able to absorb the maximum intensity of sunlight.

However, after the noon, the situation arises where the sun comes in opposite direction to the panels. In this situation, the said solar panels (100) slide on the said frame via the said sliding mechanism which are also provided at the middle portion of the said frame. Due to this, the solar panels move on the other side of the frame, in a direction facing the sunlight.

Thereafter, again the said frame along with the said panels slide on the said rail, thereby enabling the said panels to adsorb the maximum amount of sunlight.

Therefore, the above discussed configuration may allow the solar panels to track the sun according to the maximum intensity of sunlight, thus result in adsorption of more solar energy.

The frame further includes a covering adapted to cover the said solar panels in bad weather conditions.

In one embodiment of the present invention, the system further includes sensors which have an operation connection with the said solar panels. The said sensors are adapted to generate signal as the sunlight is received on the solar panels.

The said system further includes a processing system which is operatively connected with the said sensors.

In various embodiments, the said processing system adapted to receive the signal from the said sensors and process the said signal to slide/retract/tilt the solar panels for tracking the maximum intensity of the sunlight.

In one embodiment of the present invention, the surya solar system includes actuators which are having an operational connection with the said processing system. The said actuators are adapted to slide/retract/tilt/open/close the solar panels for tracking the maximum intensity of the sunlight after receiving an instruction from the processing system.

In another embodiment of the present invention, the said solar panels are foldable in the bad weather conditions, or at night.

The surya solar system is based on a mounting and a monitoring process suitable for use on solar modules of all kinds and which will make them to open and close, expand and compress, slide, retract or lie low like a pet, according to the exigencies of the weather, sun and cloud and quite unlike the present day fixed and static arrangement of existing panels.

This together with the other aspects of the present invention along with the various features of novelty that characterized the present disclosure is pointed out with particularity. For better understanding of the present disclosure, its operating advantages, and the specified objective attained by its uses, reference should be made to the accompanying descriptive matter in which there are illustrated exemplary embodiments of the present invention.

### DESCRIPTION OF THE DRAWINGS

The advantages and features of the present invention will become better understood with reference to the following detailed description taken in conjunction with the accompanying drawings, in which:

FIG. 1A illustrates a perspective view of a surya solar system in operation during morning hours of a day, according to various embodiments of the present invention;

FIG. 1B illustrates a perspective view of the surya solar system of FIG. 1A operating in the noon hours of a day, according to various embodiments of the present invention;

FIG. 1C illustrates a perspective view of the surya solar system of FIG. 1A operating in the evening hours of a day, according to various embodiments of the present invention;

FIG. 1D illustrates a perspective view of the surya solar system of FIG. 1A operating in at least one of night hours of a day, or in bad weather conditions, according to various embodiments of the present invention;

FIG. 1E illustrates a view of the surya solar system with multiple individual units as shown in FIG. 1A in operation, according to various embodiments of the present invention;

FIG. 2A illustrates a perspective view of another embodiment of the surya solar system (rotatable surya solar system) operating in morning hours of a day, according to various embodiments of the present invention;

FIG. 2B illustrates a perspective view of the rotatable surya solar system of FIG. 2A operating in noon hours of a day, according to various embodiments of the present invention;

FIG. 2C illustrates a perspective view of the rotatable surya solar system of FIG. 2A operating in evening hours of a day, according to various embodiments of the present invention;

FIG. 2D illustrates a view of multiple rotatable surya solar system of FIG. 2A arranged in operation, according to various embodiments of the present invention;

FIG. 3 illustrates another embodiment showing roof top configuration of a surya solar system, according to various embodiments of the present invention;

FIG. 3A illustrates another embodiment showing roof top configuration of a surya solar system, according to various embodiments of the present invention; and

FIG. 4 illustrates a flow chart depicting an operability of the surya solar system according to various embodiments of the present invention.

Like numerals denote like elements throughout the figures.

### DESCRIPTION OF THE INVENTION

The exemplary embodiments described herein detail for illustrative purposes are subjected to many variations. It should be emphasized, however, that the present invention is not limited to a as disclosed. It is understood that various omissions and substitutions of equivalents are contemplated as circumstances may suggest or render expedient, but these are intended to cover the application or implementation without departing from the spirit or scope of the present invention.

Specifically, the following terms have the meanings indicated below.

The terms “a” and “an” herein do not denote a limitation of quantity, but rather denote the presence of at least one of the referenced items.

The terms “having”, “comprising”, “including”, and variations thereof signify the presence of a component.

The present invention relates to a surya solar system. More specifically, the present invention discloses a solar panels system which is capable of tracking the sun and moving the said panels for adsorbing maximum amount of sunlight.

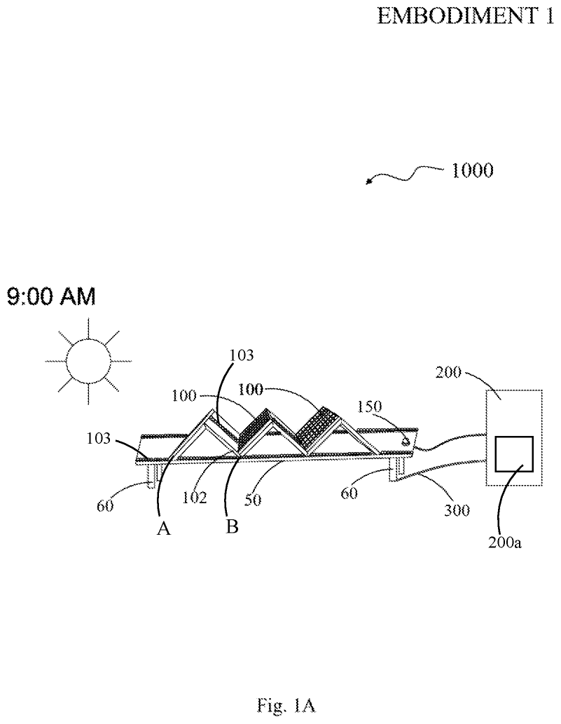

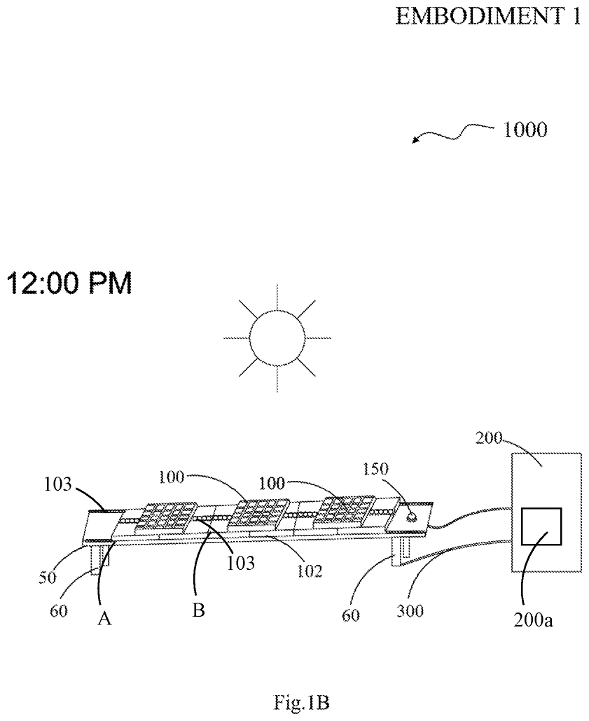

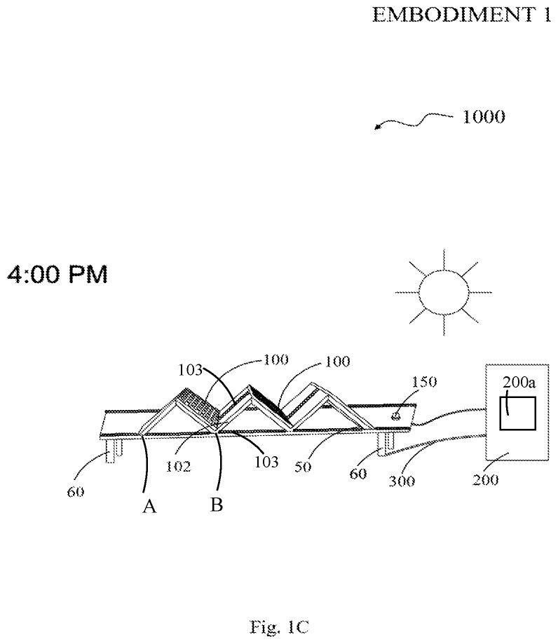

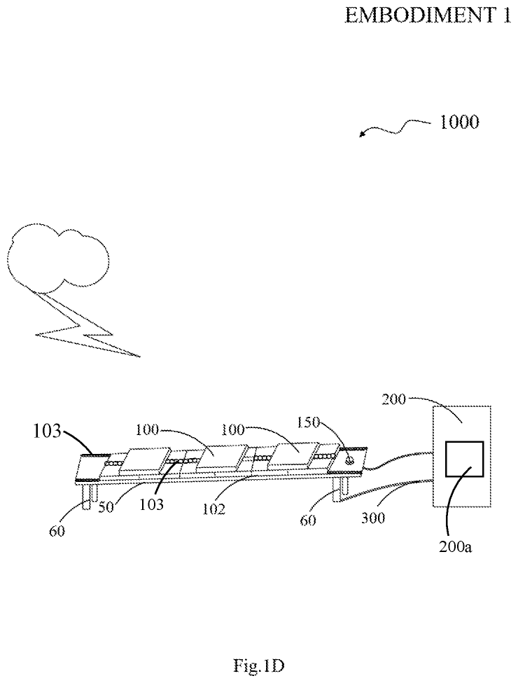

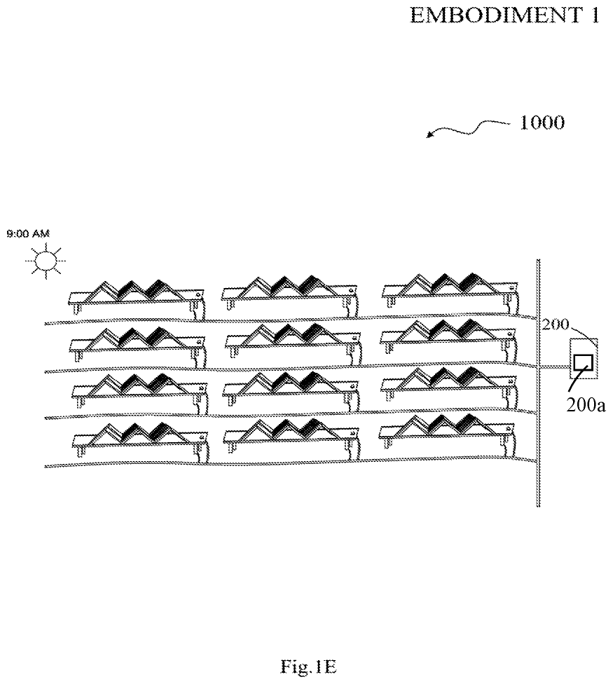

The inventive aspects of the invention along with various components and engineering involved will now be explained with reference to FIGS. 1-3 herein.

FIG. 1A-1E illustrate the surya solar system (1000), according to an embodiment of the present invention.

The said system includes a rail (50) which is mounted on a stand, such as a plurality of rods. For example, four rods (60), as shown in the Figures.

The said surya solar system (1000) further includes a frame (102) mechanically connected to the said rail (50). The said frames (102) along with the panels (100) are adapted to slide on rail (50) via a ball bearing mechanism. The ball bearing mechanism is exemplary, and other mechanically operable sliding mechanisms (103) may interchangeably be used (refer FIG. 1A-1C).

More specifically, firstly, the said frame (102) along with the panels (100) slide on the said rail (50) via the sliding mechanism (103) which is provided on the said rail (50).

In the said embodiment of the present invention, positions A & B of the frame (102) move away from each other, when the said frame (102) slides on the said rail (50) for allowing the solar panels (100) to track the maximum intensity of sunlight. Due to the said configuration, the said solar panels (100) are able to absorb the maximum intensity of sunlight (refer FIGS. 1A-1C).

However, after the noon, the situation arises where the sun comes in opposite direction to the panels (100). In this situation, the said solar panels (100) slide on the said frame (102) via the said sliding mechanism (103) which are also provided at the middle portion of the said frame (102). Due to this configuration, the solar panels (100) move on the other side of the frame (102), in a direction facing the sunlight.

Thereafter, again the said frame (102) along with the said panels (100) slide on the said rail (50).

In the said embodiment of the present invention, positions A & B of the frame (102) slide toward each other, when the said frame (102) slides on the said rail (50) for allowing the solar panels (100) to track the maximum intensity of sunlight thereby enabling the said panels (100) to adsorb the maximum amount of sunlight (refer FIGS. 1A-1C).

Therefore, the above discussed configuration may allow the solar panels (100) to track the sun according to the maximum intensity of sunlight, thus result in adsorption of more solar energy.

The surya solar system (1000) includes solar photo voltaic (PV) panels (100). These solar panels (100) are installed over the said frame (102) (refer FIGS. 1-3).

The said solar panels (100) are adapted to absorb the sunlight for converting solar energy to electricity (refer FIGS. 1-3).

In an embodiment of the present invention, the said solar panels (100) and the said frame (102) are operatively configured to the said rail (50). The said solar panels (100) in such a way that the said solar panels (100) are movable on the said frame (102) for tracking the sun for absorbing the maximum intensity of sunlight (refer FIGS. 1A-1C).

In various embodiments of the present invention, the configuration of the said solar panels (100) and the frame (102) with the rail (50), allows the solar panels (100) to track the sun accurately, and adsorb the maximum amount of sunlight to covert most of the solar energy to the electricity.

In various embodiments of the present invention, the surya solar system (1000) further includes plurality of sensors (150) has an operational connection with the said solar panels (100). The said sensors (150) are adapted to generate the signal as the sunlight is received on the said panels (100).

In the embodiment of the present invention, these sensors (150) may be ISS-DX sun sensor, ISS-TX sun sensor, ISS-AX sun sensor, MASS sensor or the like. Further, these sensors (150) are suitable tool for high accurate sun-tracking and positioning systems, with low power consumption and high reliability.

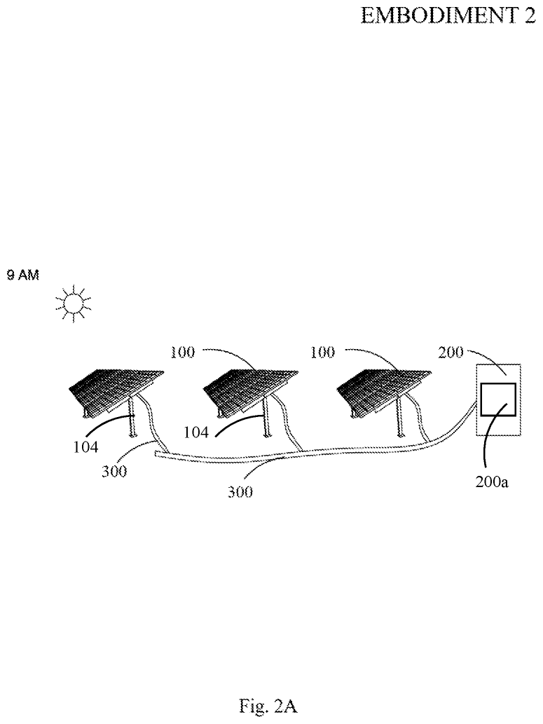

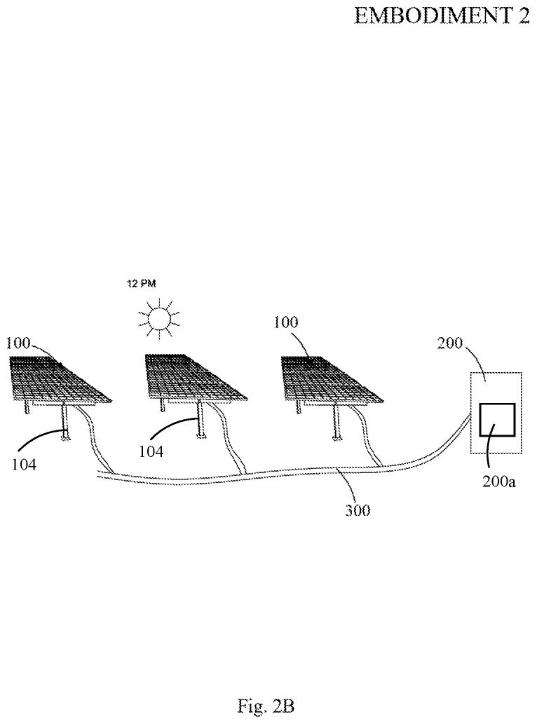

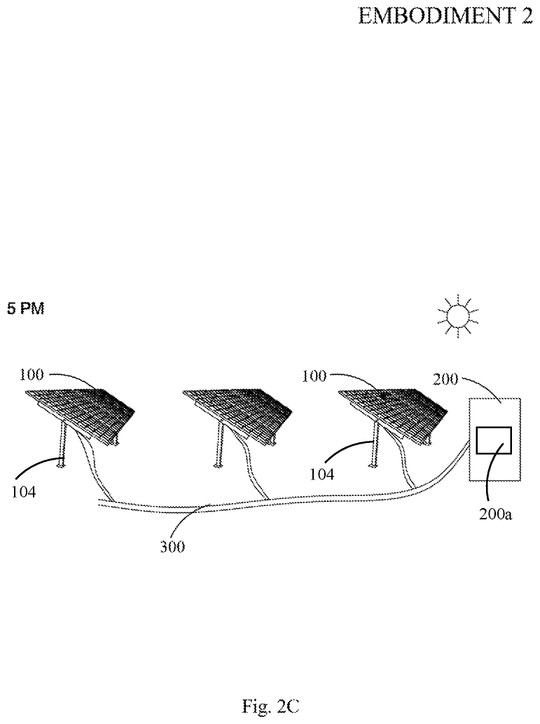

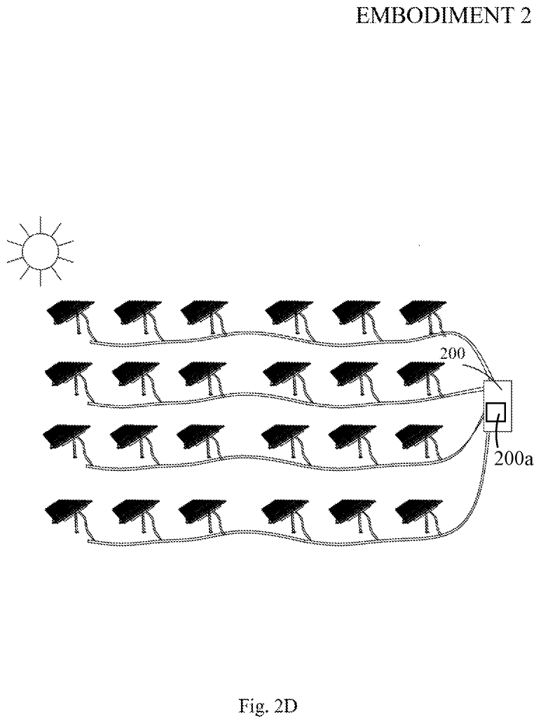

In one embodiment of the present invention, the said system (1000) further including a control room (200) to monitor or control the said panels (100) and other components. The said control room (200) is operatively connected to the said solar panels (100) via a wiring system (300) or a wireless system (refer FIGS. 1-2).

In the said embodiment of the present invention, the said control room (200) having a processing system (200a) which is operatively connected with the said sensors (150).

The said processing system (200a) is adapted to receive the signal from the said sensors (150), and process the said signal to slide/retract/tilt/open/close the solar panels (50) for tracking the maximum intensity of the sunlight.

In the said embodiment of the present invention, the said processing system (200a) is based on a mounting and monitoring process, i.e. a digital reactor system (DRS) suitable for use on solar modules of all kinds and which will make them to open and close, expand and compress, slide, retract or lie low like a pet, according to the exigencies of the weather, sun and cloud and quite unlike the present day fixed and static arrangement of present day panels.

In the embodiment of the present invention, the said system (1000) includes actuators which are having an operational connection with the said processing system (200a).

The said actuators are adapted to make the said panels (100) slide/retract/tilt/open/close, or the like for tracking the maximum intensity of the sunlight after receiving an instruction from the said processing system (200a).

More particularly, an exemplary operability of the system (1000) is shown in Figures. Referring to FIG. 1A, the surya solar system (1000) operating in morning hours is shown.

In an exemplary embodiment of the present invention, the said solar panels (100) are on left side of the frame (102) in the morning as shown in FIG. 1A.

Further, as aforesaid, the said panels (100) are capable of retracting according to the direction of sun. Such retracting is now explained in conjunction with the FIGS. 1B-1D.

In the said embodiment of the present invention, as the sun moves from east to west direction, the said solar panels (100) slide on the said frame (102) to track the sun to adsorb the maximum intensity of sunlight.

In the said embodiment of the present invention, the said frame (102) at the same time also slides on the said rail (50), thereby ensuring that the solar panels (100) are in the correct position for adsorbing the maximum intensity of sunlight (refer FIG. 1B).

Further referring to FIG. 1B, the solar panels (100) are shown to be in upright or flat position, as the position of the sun is at an apparent highest point in the sky. So, thereby to track the position of sun, the processing system (200a) activates the said mounting and monitoring process to track and move the said panels (100) for adsorbing maximum intensity of sunlight.

Referring to FIG. 1C, there is shown the position of the solar panels (100) in evening hours of a day. Again, such position is attained by activation of mounting and monitoring process to track and move the position of the panels.

Further, at night or in bad weather condition, the solar panels (100) are adapted to lay down in flat position (refer FIG. 1D). Again, such position is attained by activation of mounting and monitoring process to track and move the position of the panels.

In an embodiment of the present invention, the frame (102) includes a covering adapted to cover the solar panels (100) from both the sides of the panels (100). This protects the panels (100) from any internal or external damage.

In another embodiment of the present invention, the solar panels (100) are adapted to fold itself (like a book) in at least one of bad weather conditions or at night, thereby protecting the panels (100) from any internal or external damage.

Referring to FIG. 1E, a broader view of the FIG. 1A is shown. In the embodiment, space is provided between the rows engineers and people to walk and check the said system (1000) (All such aspects are visible in FIGS. 1A-1E).

In one embodiment of the present invention, the length of the solar panels (100) may increase in solar farms.

In another embodiment of the present invention, the solar panels (100) are rotatable (refer FIG. 2A-2C). This embodiment may be called as rotatable/tilting configuration. Such adaptability is attained by activation of mounting and monitoring process to track and move the position of the panels (100). The configuration will be more apparently clear with reference to the Drawings.

Referring to FIG. 2A, the solar panels (100) are adapted to rotate/tilt by tracking the maximum intensity of sunlight. Again, such position is attained by activation of mounting and monitoring process to track and move the position of the panels.

In the embodiment of the present invention, referring to FIGS. 2A-2C, the said solar panels (100) are adapted to tilt about a rod provided at a middle of a stand (104).

In the said embodiment of the present invention, the angle of the solar panels (100) may change as the sun moves from east direction to west direction.

For example, the said solar panels (100) are tilting towards the direction of sun, when the intensity of the sunlight is maximum, while the said panels (100) are retracted in a flat position in the noon hours of a day (refer FIG. 2B).

Similarly, the solar panels (100) rotate, and position of the solar panels (100) changes in evening is shown in FIG. 2C. Again, such position is attained by activation of mounting and monitoring process to track and move the position of the panels.

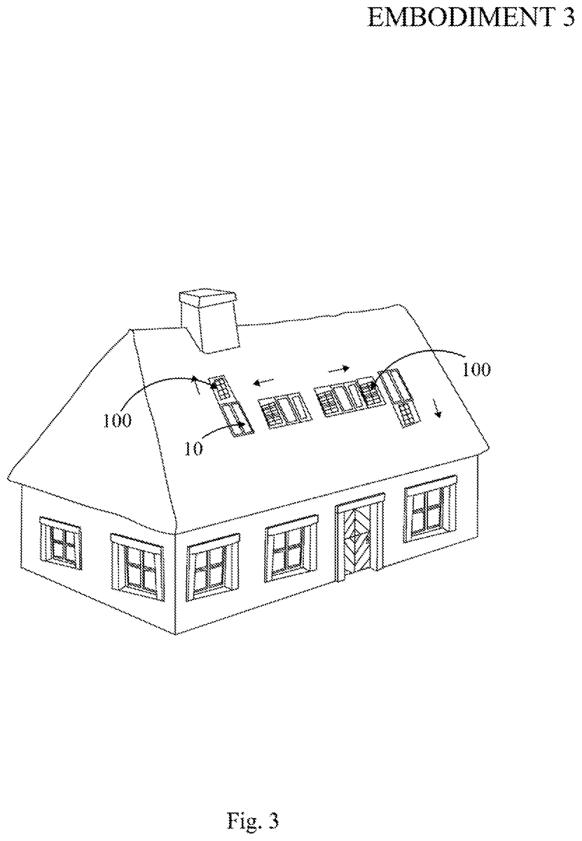

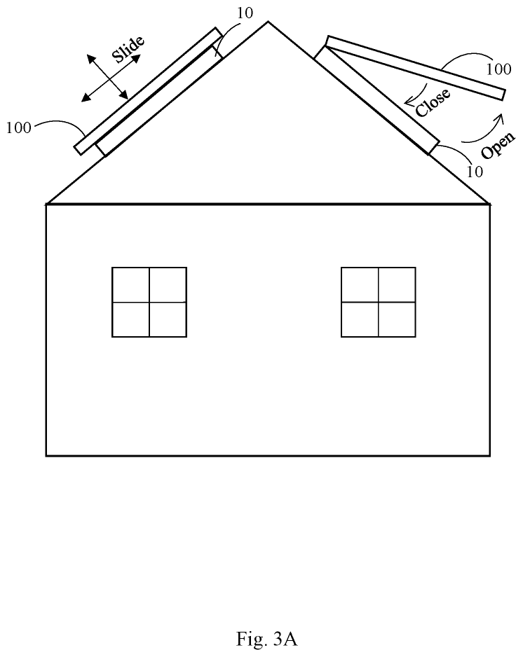

Referring to FIG. 3 now, there is shown another embodiment of the present invention. This embodiment may be called as roof top configuration of the solar panels (100).

As shown in FIG. 3, the roof is shown to be having windows (10) thereon. The said windows (10), specifically glass windows (10) include the said solar panels (100) provided on top of the said windows (10).

In one embodiment of the present invention, the windows (10) are fixed to the roof, and the solar panels (100) are adapted to slide above the said windows (10) for the receiving the sunlight (refer FIG. 3A).

In the said embodiment of the present invention, the said solar panels (100) are adapted to slide in left, right, up and down direction according to intensity of the sunlight received by the said solar panels (100) (refer FIG. 3A).

In another embodiment of the present invention, the solar panels (100) are adapted to open or close according to the sunlight (refer FIG. 3A).

In the said embodiment of the present invention, the said solar panels (100) are fixed at one side of the said windows (10) by a mechanical means such as hinges, or the like. In this manner, the said solar panels (100) are opened to receive the sunlight, the said solar panels (100) and closed in bad weather conditions or at night (refer FIG. 3A).

In yet another embodiment of the present invention, the said solar panels (100) are having one or more receptacles or hollow like structures (not shown in figure) adapted to place solar panels (100) thereon. These solar panels (100) are placed inside this hollow structures.

In the said embodiment of the present invention, the said solar panels (100) are adapted to slide in and out from the said receptacles based on the positioning of the sun. Again, such position is attained by activation of mounting and monitoring process to track and move the position of the panels (100).

More specifically, the said solar panels (100) are adapted slide out from hollow structure below the windows (10), and receive the sunlight. Further, the said solar panels (100) are adapted to slide inside this hollow structure during bad weather conditions or at night.

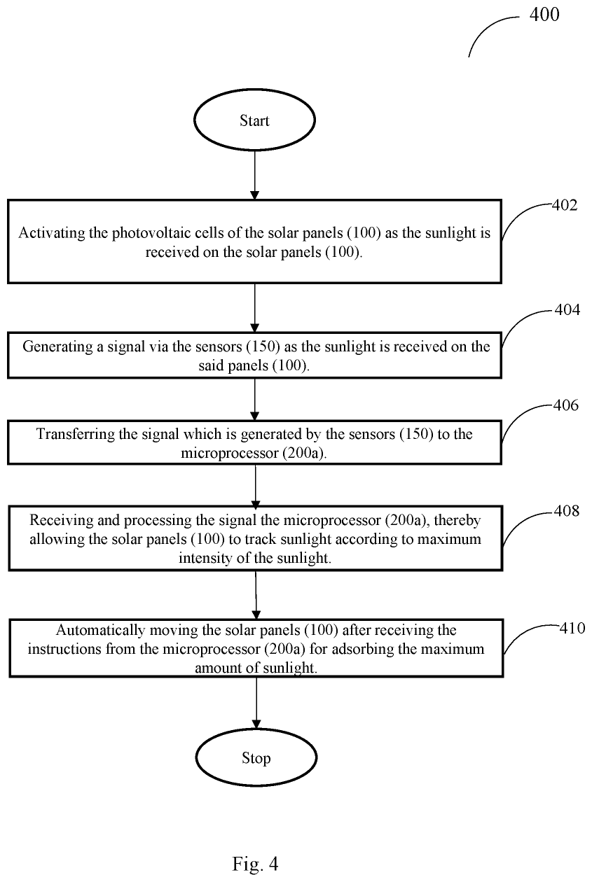

An operability of the said solar panels (100) is now explained with reference to a flowchart (400) shown in FIG. 4.

Referring to flowchart (400), at step (402), the photovoltaic cells of the solar panels (100) activate as the sunlight is received on the said panels (100).

Thereafter, at step (404), the sensors (150) generate the signal as the sunlight is received on the said panels (100).

After that, at step (406), the said signal is transferred to the said microprocessor (200a) via the said sensors (150), which are operatively connected to each other.

Further, at step (408), the microprocessor (200a) receives and processes the said signal, thereby allowing the solar panels (100) track sunlight according to maximum intensity of the sunlight.

Subsequently, at step (410), the solar panels (100) automatically move (as explained above) after receiving the instructions from the microprocessor (200a) for adsorbing the maximum amount of sunlight. The instructions are based on intensity of sunlight, direction of sunlight, or the like.

In one embodiment of the present invention, the solar panels (100) are adapted to slide in left or right direction based on the positioning of the sun. Again, such position is attained by activation of mounting and monitoring process to track and move the position of the panels.

In another embodiment of the present invention, the solar panels (100) are adapted to slide in upward or downward direction based on the positioning of the sun. Again, such position is attained by activation of mounting and monitoring process to track and move the position of the panels.

In the embodiment of the present invention, the said solar panels (100) are adapted to slide inside a hollow structure.

The said configuration is adapted to prevent the solar panels (100) from any external or internal damage in bad weather conditions.

Therefore, the surya solar system of the present invention is adapted in such a manner that the solar panels are protected from any damage in bad weather conditions.

Further, another additional feature of the present invention would be that the movement of the system would be such that tracing of the sun like the sunflower which could be incorporated in the said system (1000), the panel (100) would turn according to the sun's movement which would benefit countries with weaker sunshine.

The configuration of the said solar panels (100) with the frame (102) and the rail (50) in the present invention, allows the solar panels (100) to track the sun accurately, and adsorb the maximum amount of sunlight to convert most of the solar energy to the electricity.

Therefore, the surya solar system of the present invention overcomes above discussed drawbacks and provides easy to operate and cost-effective system.

The foregoing descriptions of specific embodiments of the present invention have been presented for purposes of description. They are not intended to be exhaustive or to limit the present invention to the precise forms disclosed, and obviously many modifications and variations are possible in light of the above teaching.

Further, the embodiments were chosen and described in order to best explain the principles of the present invention and its practical application, and thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

1. A surya solar system (1000) comprising:
a rail (50);
a frame (102) mechanically connected to the said rail (50);
a plurality of solar panels (100) configured over the said frame (102), the said solar panels (100) adapted to absorb sunlight for converting solar energy into an electricity;
a plurality of sensors (150) operatively coupled to the said solar panels (100), the said sensors (150) adapted to generate signal as the sunlight is received on the solar panels (100); and
a processing system (200a) operatively connected with the said sensors (150), the said processing system (200a) adapted to receive the said signal from the sensors (150), and process the said signal for tracking the maximum intensity of the sunlight,
wherein the said solar panels (100) and the said frame (102) are operatively configured to the said rail (50), thereby enabling the solar panels (100) to move on the said frame (102) for tracking the sun for absorbing the maximum intensity of sunlight.

2. The surya solar system (1000) as claimed in claim 1, wherein the said frame (102) is connected to said rail (50) by a sliding mechanism (103), the said frame (102) is adapted to slide over the said rail (50) for enabling the solar panels (100) to track the maximum intensity of sunlight.

3. The surya solar system (1000) as claimed in claim 3 comprising actuators having an operational connection with the said processing system (200a), the said actuators are adapted to slide/retract/tilt the solar panels (100) for tracking the maximum intensity of the sunlight after receiving an instruction from the processing system.

4. The surya solar system (1000) as claimed in claim 1, wherein the said frame (102) comprises a covering which is adapted to cover the said solar panels (100) for protecting the said panels (100) in bad weather conditions.

5. The surya solar system (1000) as claimed in claim 1, wherein the said solar panels (100) are foldable in bad weather conditions, or at night.

6. The surya solar system (1000) as claimed in claim 1, wherein the said solar panels (100) are slidable.

7. The surya solar system (1000) as claimed in claim 1, wherein the said solar panels (100) are having rotatable/tilting configuration.

8. The surya solar system (1000) as claimed in claim 6, wherein the sliding mechanism (103) is provided at the frame (102) and the rail (50).

9. The surya solar system (1000) as claimed in claim 8, wherein the said sliding mechanism (103) comprises ball bearing mechanism, or the like.

10. The surya solar system (1000) as claimed in claim 9, wherein the frame (102) along with the panels (100) are adapted to slide on the said rail (50).

11. The surya solar system (1000) as claimed in claim 9, wherein the said solar panels (100) slide on the said frame (102), when sun moves in opposite direction to the panels (100).

12. The surya solar system (1000) as claimed in claim 7, wherein the said solar panels (100) are adapted to tilt about a rod provided on a stand (104).

13. The surya solar system (1000) as claimed in claim 1, wherein the said solar panels (100) are provided above the windows (10) of roof, the said panels (100) are adapted to slide in left, right, up and down according to the intensity of the sunlight.

14. The surya solar system (1000) as claimed in claim 13, wherein the solar panels (100) are open or close according to the intensity of the sunlight.
